(19) United States
(12) Patent Application Publication
(10) Pub. No.: US 2017/0255881 A1
(43) Pub. Date: Sep. 7, 2017

(54) SYSTEMS AND METHODS OF CONTROLLING DIGITAL SIGNAGE FOR DIRECTING PARKING TRAFFIC

(71) Applicant: Westfield Labs Corporation, San Francisco, CA (US)

(72) Inventors: Antony Ritch, San Francisco, CA (US); Erik Davin Kokkonen, San Francisco, CA (US)

(21) Appl. No.: 15/057,957

(22) Filed: Mar. 1, 2016

(51) Int. Cl. G06Q 10/02; G08G 1/14

(52) U.S. Cl. CPC G06Q 10/02; G08G 1/142

(57) ABSTRACT

A system including: a parking lot having a plurality of parking spaces; at least one device positioned in the parking lot to identify occupancy statuses of the parking spaces; a plurality of display devices positioned next to and facing the parking spaces respectively; and a server computer storing parking space reservations that include identification information of vehicles for which the reservations are made. The server computer is further configured to generate and present navigational guidance on the display devices based on identification information of vehicles in the vicinity of the parking spaces and reservations.

### FIELD OF THE TECHNOLOGY

At least some embodiments disclosed herein relate to the control of vehicle traffic in a parking lot.

### BACKGROUND

Computer technologies have been used to improve various aspects related to parking lots.

U.S. Pat. App. Pub. No. 2012/0236149, entitled “Parking Lot,” discloses a parking lot that has cameras to read the license plates of parked vehicles via optical character recognition (OCR) and radio beacons to read out the radio IDs carried on the vehicles. A central computer is configured to store parking space reservations in association with vehicle license numbers and radio IDs. The identification of an entering vehicle takes place via radio, while the localization and validation of the vehicle in the parking space is realized with OCR of license plates. When the parking space is equipped with electric vehicle charging stations, the central computer can unlock the charging station for charging a vehicle after successfully checking the vehicle license number signaled by the camera of the respective parking space, such that the improper use of charging stations is precluded.

U.S. Pat. App. Pub. No. 2008/0033769, entitled “Personalized Parking and Reservation System,” discloses a parking facility having a ticket dispenser and parking space sensors and aisle sensors to detect the movements of vehicles in the parking facility. The ticket dispenser permits entry of parking space preference information. Based on the personal preference of a parking patron, a computer is configured to identify a recommended parking space, and send the location of the recommended parking space to the ticket dispenser. The ticket dispenser prints a map and textual instructions after the parking authorization.

U.S. Pat. App. Pub. No. 2014/0195282, entitled “Computer-Implemented System And Method For Offering Customer Priority Parking Reservations,” discloses a system that has a vehicle occupancy sensor to sense occupancy of a parking space by a motor vehicle, a smart parking device to determine an identity of the driver of the motor vehicle, and parking availability indicators associated with the reserved parking spaces that are activated throughout the reservation period in a merchant priority parking mode.

U.S. Pat. App. Pub. No. 2014/0350855, entitled “Systems and Methods for Providing Navigational Assistance to Reserved Parking Locations,” discloses a system that when a vehicle is detected to be occupying a parking space different from a space reserved for the vehicle and the parking space is not available for the vehicle, presents a prompt requesting the vehicle to be moved to an alternative parking space via a parking application running in a user access device.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a parking lot configured to control parking traffic according to one embodiment.

FIG. 2 shows a system to manage parking according to one embodiment.

FIG. 3 shows a method to manage parking according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Embodiments disclosed herein provide further improvements to aspects related to parking lots. For example, digital signage is used in some embodiments to provide navigational guidance for directing the drivers of the vehicles to park the vehicles to proper parking spaces.

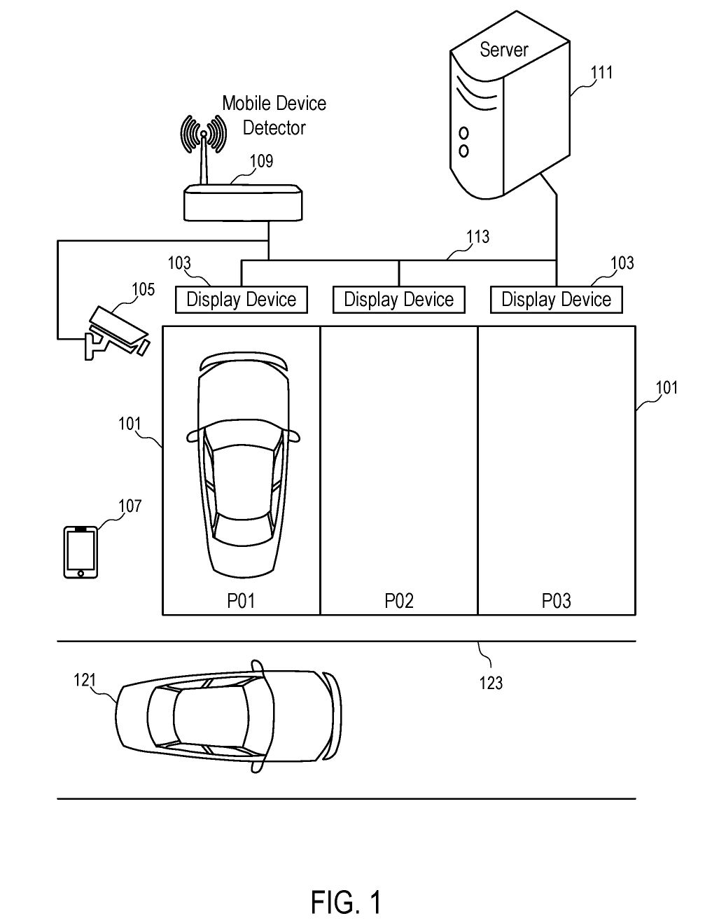

FIG. 1 shows a parking lot configured to control parking traffic according to one embodiment.

In FIG. 1, the system includes a parking lot having a plurality of parking spaces (101). Each of the parking spaces (101) is marked for the parking of one vehicle (121).

In FIG. 1, a display device (103) is installed in front of each of the parking spaces (101). The display device (103) faces the respective parking space in front of which the display device (103) is installed.

The FIG. 1, a camera (105) is configured in the vicinity of the parking spaces (101) to detect the presence and/or movements of the vehicles (101). Alternatively or in combination, other devices can be used to determine the presence of a vehicle in a parking space or a drive way or aisle (123), such as the parking space sensors and aisle sensors disclosed in U.S. Pat. App. Pub. No. 2008/0033769, the entire disclosure of which application is hereby incorporated herein by reference.

In FIG. 1, a mobile device detector (109) is configured to detect the identity of the vehicles in the vicinity of the parking spaces (101) based on the mobile devices (e.g., 107) carried by the drivers and/or passengers of the vehicles.

For example, the mobile device detector (109) of one embodiment detects the identity of a vehicle based on the identity revealed in wireless signals (e.g., Bluetooth or WiFi signals) emitted from the mobile device (107) carried by the driver (or a passenger) of the vehicle (121).

For example, the mobile device (107) is configured with a mobile application that establishes a connection with the mobile device detector (109) via a wireless communication channel (e.g., a wireless personal area network using Bluetooth, a wireless local area network using WiFi) when the mobile device (107) is with the range of the wireless communication channel. The mobile application provides an identifier indicating the identity of the vehicle. The identifier may be a telephone number of the user of the vehicle, a member ID of the user, a license plate number of the vehicle, a driver's license number of the user, an identity of a person who made a reservation for the vehicle, an identification code of a parking space reservation for the vehicle, etc.

In FIG. 1, a server (111) is connected to the camera (105), the display devices (103) and the mobile device detector (109) to receive real time information collected by the camera (105), the display devices (103) and the mobile device detector (109).

Further, the server (111) is configured to store parking space reservation data. For example, the server (111) may include a web server that receives parking space reservations that have the identity information for the associated vehicles, such that the identification information determined by the mobile device detector (109) can be used to determine whether a corresponding vehicle has a parking space reservation.

In some embodiments, a vehicle is identified using a combination of a radio identification (e.g., provided via the mobile device (107)) and the vehicle license plate number. For example, when the vehicle (121) carrying the mobile device (107) is detected at a particular location within or near the parking lot, the vehicle license plate number of the vehicle is captured (e.g., via a camera) and associated with the identification information provided by the mobile application running in the mobile device (107) (or from the wireless signals emitted from the mobile device (107)). Thus, subsequently locations of the vehicle can be identified from the location of the mobile device (107) and/or camera images that capture the license plate of the vehicle.

In one embodiment, when a vehicle approaches one or more parking spaces (101), the server (111) determines the identity of the vehicle (101) via the camera (105) and/or the mobile device detector (109). For example, the identifier obtained from the mobile device detector (109) and/or the license plate recognized by the camera (105) via optical character recognition (OCR) can be used to match with the reservation records to determine whether the vehicle has a reservation. Optionally, the server (111) further identifies the preference of the user of the vehicle (e.g., based on the planned destination of the user, such as a location to pick up a purchased item, a retail store next to the parking lot). For example, a merchant of a retail store may reserve a parking space for the customer when the customer has an appointment with the merchant for a period of time. For example, the customer may request the server (111) to reserve a parking space for a scheduled trip to a merchant located next to the parking lot.

In one embodiment, the server (111) provides a user interface that allows the merchant or the customer to request a reservation of a specific parking space. For example, the server (111) presents a map of the available parking spaces that allows the user of the map to select a parking space and identify a time period for the reservation.

In another embodiment, the server (111) is configured to assign a parking space from a pool of reserved parking spaces after the vehicle of the customer arrives at the parking lot.

In FIG. 1, the server (111) is configured to generate navigational guidance based on the identity of the vehicle approaching the parking spaces (101), the reservation data, and the occupancy statuses of the parking spaces (101).

For example, when the vehicle (121) having an applicable reservation approaches the parking spaces P02 and P03 illustrated in FIG. 1, the server (111) determines that the parking space P02 is assigned to the vehicle (121). Thus, the server (111) causes the display device in front of the parking space P02 to present a navigational guidance to welcome the vehicle to parking in the parking space P02, while causing the display device in front of the parking space P03 to present a navigational guidance to discourage the drive to park the vehicle in the parking space P03.

For example, to guide the vehicle into the parking space P02, the display device in front of the parking space P02 is updated to show the message “Welcome” and/or a graphical illustration suggesting the driver to pull the vehicle into the parking space P02. The message of one embodiment is further personalized to include an identification of the vehicle (121), such as the license plate number of the vehicle (121), a confirmation code for the reservation made for the user of the vehicle (121), the maker and/or model of the vehicle (121), a merchant who made the reservation for the user of the vehicle (121), a name of the user of the vehicle (121), etc.

For example, to discourage the vehicle from entering the parking space P03, the display device in front of the parking space P03 is updated to show the message “Not Available” and/or a graphical illustration suggesting the parking space P03 is not available. The message of one embodiment is further personalized to include an identification of the vehicle (121), such as the license plate number of the vehicle (121), a confirmation code for the reservation made for the user of the vehicle (121), the maker and/or model of the vehicle (121), a merchant who made the reservation for the user of the vehicle (121), a name of the user of the vehicle (121), etc.

For example, when the server (111) determines that the vehicle (121) is allowed to take any of the parking spaces P02 and P03, the display devices in front of the parking spaces P02 and P03 can be both updated to show a green light to welcome the vehicle.

For example, when the server (111) determines that the vehicle (121) does not have a valid parking reservation, the server (111) updates the display devices (103) in front of the parking spaces P02 and P03 to show the message “Reserved” and/or a red light to discourage the vehicle from entering the parking spaces P02 and P03.

In one embodiment, the part lot has a reserved area of parking spaces (101) that require reservation and a non-reserved area of parking spaces (e.g., at a less convenient location). When the vehicle (121) having no reservation approaches the parking spaces P02 and P03, the server (111) updates the display devices (103) in front of the parking spaces P02 and P03 to provide navigational guidance to the non-reserved area.

In one embodiment, when the vehicle (121) enters the parking space (101) that is not assigned to the vehicle (121), the server (111) is configured to determine whether the parking lot has sufficient resources to accommodate both the vehicle (121) and the applicable reservations in its database. If so, the server (111) is configured to assign the space (101) to the vehicle (121) and compute a price for using the space (101). The price may include a premium/surcharge for not having a reservation. The user of the parking space (101) may use the mobile device to request a time period for using the parking space (101) and/or pay the price.

If the parking lot has insufficient resources to accommodate both the vehicle (121) and the applicable reservations in its database, the display device (103) in front of the parking space (101) is updated to warn the driver of the vehicle for improper parking and/or request the user of the vehicle to present evidence of reservation. The navigational guidance provided on the display device (103) further provide the instructions/directions to the non-reserved area of parking spaces.

In one embodiment, when the server (111) fails to connect the vehicle (121) to a reservation (e.g., based on the identification information obtained from the mobile device detector (109) and/or the camera (105)), the user may present a confirmation code of the reservation (e.g., via the mobile device) to cause the server to accept the vehicle at the parking space (101).

In one embodiment, to guide the vehicle (121) from its current position in the parking lot to an assigned parking space, or the non-reserved area of parking spaces, the mobile device (107) is configured to receive turn-by-turn navigational instructions from the server (111) for presentation on the infotainment system of the vehicle (121).

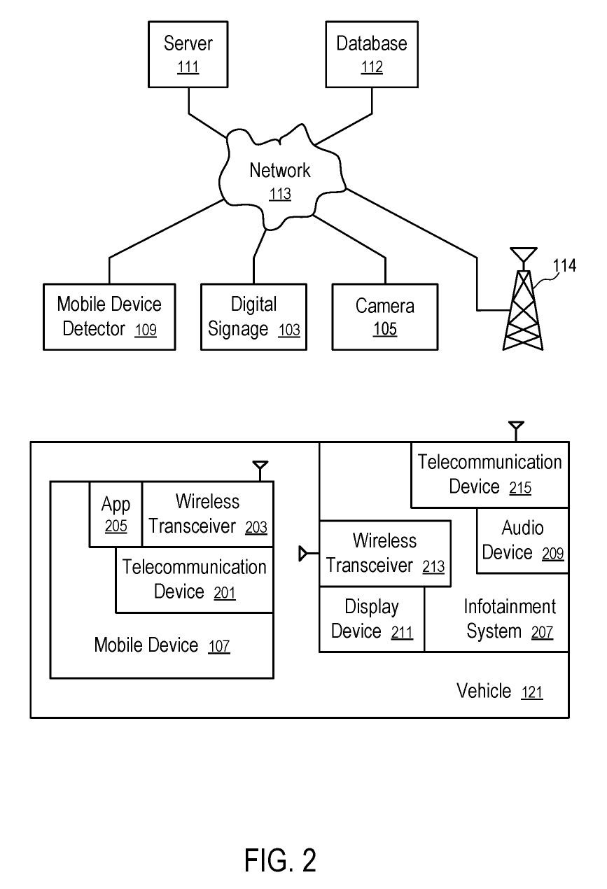

FIG. 2 shows a system to manage parking according to one embodiment. For example, the system of FIG. 2 can be configured in a parking lot illustrated in FIG. 1.

In FIG. 2, the vehicle (121) has an infotainment system (207), including a display device (211) and an audio device (209) for presenting information transmitted from the mobile device (107).

The mobile device (107) and the vehicle (121) have wireless transceivers (203 and 213) that can be used by the mobile application (205) to establish a wireless communication connection. Thus, navigational guidance received from the server (111) can be transmitted from the mobile application (205) to the infotainment system (207) for presentation.

In one embodiment, the mobile device (107) is configured to use a telecommunication device (201) to establish a connection via a base station of a telecommunication network (e.g., a cellular communications network) with the server (111) to obtain the turn-by-turn navigational instructions.

Alternatively or in combination, the mobile device (107) is configured to use a wireless local area network connection (e.g., WiFi) to the mobile device detector (109) to obtain the turn-by-turn navigational instructions.

In some embodiments, the vehicle (121) includes a telecommunication device (215); and the mobile application (205) can instruct the infotainment system (207) to obtain the turn-by-turn navigational instructions directly from the server (111) without going through the mobile device (107).

In one embodiment, the vehicle (121) is equipped with an autonomous drive module. Upon approval by the driver of the user, the navigational instructions from the server (111) causes the vehicle (121) to drive to a parking space assigned by the server (111) in an autonomous mode.

In FIG. 2, the database (112) stores parking reservation data that associates reservations (e.g., time slots for the reservation and/or the identifications of the reserved parking spaces) with identification information that can be used to determine whether a vehicle corresponds to a respective reservation, such as a confirmation number, a phone number of a driver of the vehicle, the license plate number of the vehicle, a member ID, etc.

In one embodiment, the database (112) further stores map data of the parking lot and the vacancy/occupancy statuses of the parking spaces (101), indicating for each of the parking spaces whether or not the parking space is currently vacant or occupied.

In FIG. 2, at least one camera (105) installed in vicinity of the parking spaces is used by the server (111) to periodically survey the vacancy/occupancy statuses of the parking spaces (101). Other types of devices/sensors can also be used in the parking lot to determine the vacancy/occupancy statuses of the parking spaces (101) and communicate the information to the server (111) and/or the database (112) via the network (113).

In FIG. 2, the digital signage (103) is controlled by the server (111) to provide navigational guidance (e.g., through the display devices (103)) mounted in front of the parking spaces (103).

In FIG. 2, the mobile device detector (109) is configured to determine the identity of the vehicle (121) based on communications with the mobile application (205) while the mobile device (107) is within the wireless communication range, and/or based on identification information embedded in the wireless signals emitted from the mobile device (107) without establishing a communication connection between the mobile device detector (109) and the mobile device (107).

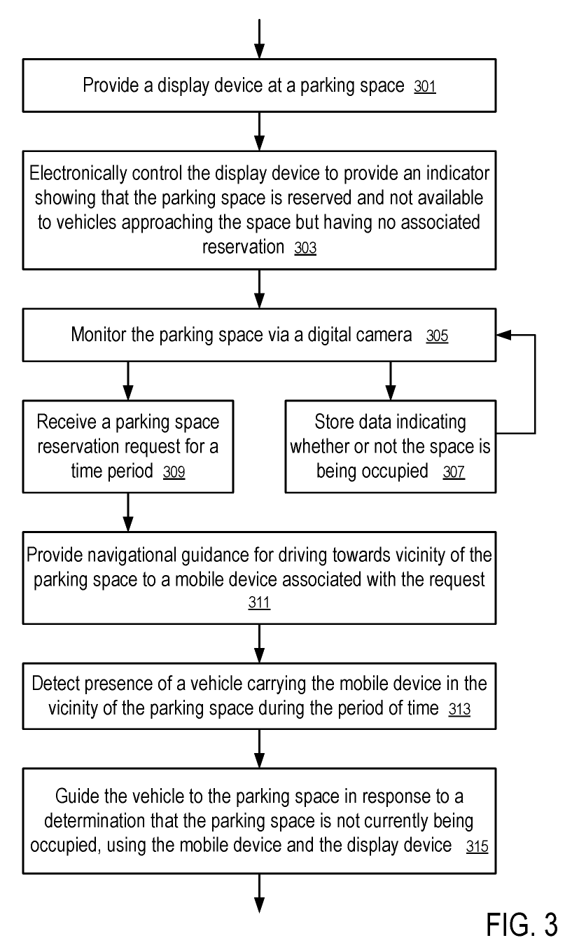

FIG. 3 shows a method to manage parking according to one embodiment. For example, the method of FIG. 3 can be implemented in the parking lot of FIG. 1 using the system illustrated in FIG. 2.

In FIG. 3, a data processing system is configured to: provide (301) a display device (103) at a parking space (101); electronically (303) control the display device (101) to provide an indicator showing that the parking space (101) is reserved and not available to vehicles approaching the parking space (101) but having no associated reservation; monitor (305) the parking space (101) via a digital camera (105) to determine whether or not the parking space (101) is being occupied; store (307) data indicating whether or not the space is being occupied; receive (309) a parking space reservation request for a time period; provide (311), to a mobile device associated with the request, navigational guidance for driving towards vicinity of the parking space; detect (313) presence of a vehicle (121) carrying the mobile device in the vicinity of the parking space during the period of time; and guide (315), using the mobile device (107) and the display device (103), the vehicle (121) to the parking space (101) in response to a determination that the parking space is not currently being occupied.

In one aspect, a method includes: providing a display device facing a parking space in a parking lot; receiving, in the server via a data communication network, sensor input indicating occupancy statuses of parking spaces in the parking lot; receiving, in the server, reservation requests that contain identification information of vehicles; detecting presence of a vehicle in vicinity of the parking space at a time when the parking space is not occupied; determining, by a device in the parking lot, identification information of the vehicle in the vicinity of the parking space; generating, by the server, a navigational guidance for the vehicle based on the occupancy statuses of parking spaces in the parking lot and the reservation requests; and presenting on the display device the navigational guidance the vehicle.

For example, in response to a determination that the vehicle does not have a parking space reservation in the parking lot, the navigational guidance discourages a driver of the vehicle to park the vehicle in the parking space. The method may further includes: identifying an area in the parking lot where no reservation is required for parking spaces in the area; wherein the navigational guidance includes instructions of driving from the vicinity of the parking space to the area in the parking lot.

In response to a determination that the vehicle having no applicable reservation is parked in the parking space, the method further includes determining whether availability of parking spaces in the parking lot is sufficient to meet the reservation requests. In response to a determination that the availability of parking spaces in the parking lot is sufficient to meet the reservation requests, a price for the parking space is determined for the vehicle having no applicable reservation but occupying the parking space that requires a reservation; and the display device is configured to prompt the driver of the vehicle to accept the price for using the parking space. The price of one embodiment includes a surcharge for occupying the parking space without an applicable reservation.

In response to a determination that the availability of parking spaces in the parking lot is insufficient to meet the reservation requests, the display device is updated to present a message requesting the driver of the vehicle to move the vehicle out of the parking space, when the vehicle currently occupying the parking space that requires a reservation has no applicable reservation.

In response to a determination that a vehicle having a parking space reservation is in the parking lot, the method further determines whether the parking space in the vicinity of the vehicle is assignable to the vehicle. In response to a determination to assign the parking space to the vehicle, the navigational guidance welcomes the driver of the vehicle to park the vehicle in the parking space. In response to a determination that an alternative parking space is assigned to the vehicle, the navigational guidance includes instructions directing the vehicle to the alternative parking space.

In one embodiment, a communication connection is established between the server and a mobile device on the vehicle; and the server provides navigational guidance to the mobile device via the communication connection. For example, the mobile device is configured with a mobile application to establish the communication connection with a mobile device detector located in the parking lot to receive the navigational guidance, and communicate the navigational guidance to an infotainment system of the vehicle for presentation.

In one embodiment, the identification information of the vehicle is determined based at least in part on the communication connection and provided by the mobile application.

In another aspect, a system includes: a parking lot having a first area of parking spaces, where each of the parking spaces is configured to be occupied by one vehicle; at least one device positioned in the parking lot to identify occupancy statuses of the parking spaces; a plurality of display devices positioned next to and facing the parking spaces respectively; and a server computer storing parking space reservations that include identification information of vehicles for which the reservations are made. The server computer is further configured to generate and present navigational guidance on the display devices based on identification information of vehicles in the vicinity of the parking spaces and reservations.

The system of one embodiment further includes a mobile device detector configured in the first area, where the identification information of the vehicles in the vicinity of the parking spaces is determined via the mobile device detector communicating with mobile devices carried on the vehicles in the vicinity of the parking spaces.

For example, a mobile application is configured in the mobile devices to provide the identification information of the vehicles in the vicinity of the parking spaces.

The parking lot of one embodiment further has a second area of parking spaces; the parking spaces in the first area require reservations; the parking spaces in the second area require not reservations; the navigational guidance directs first vehicles having reservations in the server computer to parking spaces assigned to the first vehicles in the first area and direct second vehicles having no reservations in the server computer to the second area.

In one embodiment, the navigational guidance is generated based at least in part on positions of the vehicles in the vicinity of the parking spaces relative to the parking spaces. For example, the navigational guidance of one embodiment includes turn by turn instructions based on the current location of the vehicle/mobile device.

The mobile device detector (109), the server (111) and/or the database (112) as illustrated in FIGS. 1 and 2 can be implemented using a data processing system with fewer or more components.

For example, a data processing system includes an inter-connect (e.g., bus and system core logic), which interconnects a microprocessor(s) and memory. The microprocessor is coupled to cache memory.

In one embodiment, the inter-connect interconnects the microprocessor(s) and the memory together and also interconnects them to input/output (I/O) device(s) via I/O controller(s). I/O devices may include a display device and/or peripheral devices, such as mice, keyboards, modems, network interfaces, printers, scanners, video cameras and other devices known in the art. In one embodiment, when the data processing system is a server system, some of the I/O devices, such as printers, scanners, mice, and/or keyboards, are optional.

In one embodiment, the inter-connect includes one or more buses connected to one another through various bridges, controllers and/or adapters. In one embodiment the I/O controllers include a USB (Universal Serial Bus) adapter for controlling USB peripherals, and/or an IEEE-1394 bus adapter for controlling IEEE-1394 peripherals.

In one embodiment, the memory includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
providing a display device facing a parking space in a parking lot, wherein the display device is connected to a server;
receiving, in the server via a data communication network, sensor input indicating occupancy statuses of parking spaces in the parking lot;
receiving, in the server, reservation requests that contain identification information of vehicles;
detecting presence of a vehicle in vicinity of the parking space at a time when the parking space is not occupied;
determining, by a device in the parking lot, identification information of the vehicle in the vicinity of the parking space;
generating, by the server, a navigational guidance for the vehicle based on the occupancy statuses of parking spaces in the parking lot and the reservation requests; and
presenting on the display device the navigational guidance the vehicle.

2. The method of claim 1, wherein in response to a determination that the vehicle does not have a parking space reservation in the parking lot, the navigational guidance discourages a driver of the vehicle to park the vehicle in the parking space.

3. The method of claim 2, further comprising:
identifying an area in the parking lot where no reservation is required for parking spaces in the area;
wherein the navigational guidance includes instructions of driving from the vicinity of the parking space to the area in the parking lot.

4. The method of claim 2, further comprising:
in response to a determination that the vehicle is parked in the parking space, determining whether availability of parking spaces in the parking lot is sufficient to meet the reservation requests.

5. The method of claim 4, further comprising:
in response to a determination that the availability of parking spaces in the parking lot is sufficient to meet the reservation requests,
determining a price for the parking space; and
prompting, via the display device, the driver of the vehicle to accept the price for using the parking space.

6. The method of claim 5, wherein the price includes a surcharge for occupying the parking space without an applicable reservation.

7. The method of claim 4, further comprising:
in response to a determination that the availability of parking spaces in the parking lot is insufficient to meet the reservation requests, presenting on the display device a message requesting the driver of the vehicle to move the vehicle out of the parking space.

8. The method of claim 1, further comprising,
in response to a determination that the vehicle has a parking space reservation in the parking lot, determining whether the parking space is assignable to the vehicle.

9. The method of claim 8, wherein in response to a determination to assign the parking space to the vehicle, the navigational guidance welcomes the driver of the vehicle to park the vehicle in the parking space.

10. The method of claim 8, wherein in response to a determination that an alternative parking space is assigned to the vehicle, the navigational guidance includes instructions directing the vehicle to the alternative parking space.

11. The method of claim 1, further comprising:
establishing a communication connection with a mobile device on the vehicle; and
providing navigational guidance to the mobile device via the communication connection.

12. The method of claim 11, wherein the mobile device is configured with a mobile application to establish the communication connection with a mobile device detector located in the parking lot.

13. The method of claim 12, wherein the mobile device is further configured to communicate the navigational guidance to an infotainment system of the vehicle for presentation.

14. The method of claim 12, wherein the identification information of the vehicle is determined based at least in part on the communication connection and provided by the mobile application.

15. A non-transitory computer storage medium storing instructions configured to instruct a computing device to perform a method, the method comprising:
receiving, in a server via a data communication network, sensor input indicating occupancy statuses of parking spaces in the parking lot;
receiving, in the server, reservation requests that contain identification information of vehicles;
detecting presence of a vehicle in vicinity of a parking space at a time when the parking space is not occupied;
determining, by a device in the parking lot, identification information of the vehicle in the vicinity of the parking space;
generating, by the server, a navigational guidance for the vehicle based on the occupancy statuses of parking spaces in the parking lot and the reservation requests; and
presenting, on a display device facing a parking space in a parking lot, the navigational guidance the vehicle.

16. A system, comprising:
a parking lot having a first area of parking spaces, each of the parking spaces configured to be occupied by one vehicle;
at least one device positioned in the parking lot to identify occupancy statuses of the parking spaces;
a plurality of display devices positioned next to and facing the parking spaces respectively; and
a server computer storing parking space reservations that include identification information of vehicles for which the reservations are made, the server computer further configured to generate and present navigational guidance on the display devices based on identification information of vehicles in the vicinity of the parking spaces and reservations.

17. The system of claim 16, further comprising:
a mobile device detector configured in the first area, wherein the identification information of the vehicles in the vicinity of the parking spaces is determined via the mobile device detector communicating with mobile devices carried on the vehicles in the vicinity of the parking spaces.

18. The system of claim 17, wherein a mobile application is configured in the mobile devices to provide the identification information of the vehicles in the vicinity of the parking spaces.

19. The system of claim 18, wherein the parking lot having a second area of parking spaces; the parking spaces in the first area require reservations; the parking spaces in the second area require not reservations; the navigational guidance directs first vehicles having reservations in the server computer to parking spaces assigned to the first vehicles in the first area and direct second vehicles having no reservations in the server computer to the second area.

20. The system of claim 16, wherein the navigational guidance is generated based at least in part on positions of the vehicles in the vicinity of the parking spaces relative to the parking spaces.
